(19) United States
(12) Patent Application Publication
(10) Pub. No.: US 2011/0165544 A1
(43) Pub. Date: Jul. 7, 2011

(54) ACTIVITY DATA PRESENTING APPARATUS, ACTIVITY DATA PRESENTING METHOD AND RECORDING MEDIUM

(75) Inventors: Satoko Itaya, Tokyo (JP); Taku Konishi, Tokyo (JP); Rie Tanaka, Tokyo (JP); Shinichi Doi, Tokyo (JP)

(73) Assignee: NEC CORPORATION, Tokyo (JP)

(21) Appl. No.: 13/063,711

(22) PCT Filed: Aug. 24, 2009
(86) PCT No.: PCT/JP2009/064722

§ 371 Date: Mar. 11, 2011

(30) Foreign Application Priority Data
Sep. 11, 2008 (JP) 2008-233983

(51) Int. Cl. G09B 19/00

(52) U.S. Cl. 434/236

(57) ABSTRACT

An activity data presenting apparatus includes an activity information obtaining unit that obtains activity data representing a human activity, a personality data obtaining unit that obtains personality data representing the personality of a person to whom information is presented, a presenting data selecting unit that selects, on the basis of the person to whom the information is presented and of the personality data of that person, data to be presented among the activity data, a display method selecting unit that selects a display method of displaying the data to be presented corresponding to each piece of the personality data, an activity data processing unit that processes the activity data in accordance with the display method selected by the display method selecting unit, an activity data display unit that displays the activity data processed by the activity data processing unit, and a display unit.

### TECHNICAL FIELD

The present invention relates to an activity presenting apparatus, an activity data presenting method and a recording medium which present data representing human activities to a person who takes such activities.

### BACKGROUND ART

In the present days in which an ubiquitous society is promoted, how computers and systems support user's life and activity is getting attention. What is particularly important is to build a system for promoting a health management of people and for supporting user activities in order to reduce a burden of living activities on the environment.

Patent Literature 1 discloses an example of a healthcare system. According to the technology in Patent Literature 1, an inclined half mirror is provided at a position inwardly of the wash stand and facing a user, and a video camera is mounted behind the half mirror. Moreover, a monitor is provided at the bottom part of the half mirror, and an image, which is output by a separate computer for processing such an image, is displayed. The computer generates data for healthcare based on various information measured while the user is asleep with the user being unrestrained, synthetic such data with the images of the user from the video camera, and displays the synthesize image on the monitor. The users can automatically view healthcare information when going to the wash stand in the morning as a daily movement when waking up.

Moreover, Patent Literature 2 discloses an example of a living-activity improving/supporting apparatus in order to reduce an environmental burden. According to the technology in Patent Literature 2, based on data (data on an amount of activity before the improvement) representing an amount of activity of each activity of a user before the improvement of the living activity (e.g., a time at which the user takes a living activity), an amount of change in the amount of activity of another living activity when the amount of activity of a living activity increases by one unit is calculated, and based such calculated amount of change, an amount of change in the environmental burden (e.g., a usage amount of water and electricity) is calculated. A message is allocated which prompts the user to reduce the amount of activity of the living activity that increases the environmental burden, and a message is allocated which prompts the user to increase the amount of activity of the living activity that reduces the environmental burden. For each living activity, an amount of reduction of the environmental burden for each living activity is calculated based on an amount of change in each living activity between data of the amount of activity after the improvement representing the living activity of the user measured when the message allocated to the living activity is presented to the user, and the data of the amount of activity before the improvement, and a message allocated to the living activity which has the largest amount of reduction of the environmental burden is selected. That is, the living-activity improving/supporting apparatus presents a message in order to decrease the amount of activity when the environmental burden increases; and presents a message in order to increase the amount of activity when the environmental burden decreases, thereby improving the living activity of the user directed to the reduction of the environmental burden.

Furthermore, Patent Literature 3 discloses a technology that provides risk information in an expression acceptable to a user for each user. Storage means of Patent Literature 3 stores information representing an individual difference in understanding of the risk information as attribute information of plural users. Attribute map storage means stores an attribute map representing a relationship between plural clusters that correspond to the attribute information of individual users and a relation level of a user response to plural analyzing items. When no attribute information of the user is stored, generating means generates the attribute information of the user based on the attribute map. The storage means further obtains various kinds of processed data and stores those. Processing means processes various kinds of data into an expression form appropriate for an authenticated user based on the stored attribute information or the generated attribute information. Presentation means presents the various kinds of processed data to the authenticated user.

On the other hand, in order to improve an educational achievement in a school education and a business result in a company in past, ranks and records of activities of all members belonging to a group are announced to the group, expecting the voluntary improvement of the activities in future.

In addition, as a method of presenting data to a user, Patent Literature 4 discloses a technology that distributes streaming media appropriate to the user. As a related technology, Patent Literature 5 discloses a technology of identifying an intended communication counterparty and of searching communication-counterparty information that is necessary for a communication.

### PRIOR ART DOCUMENT

### Patent Literature

Patent Literature 1: Unexamined Japanese Patent Application KOKAI Publication No. 2002-183315
Patent Literature 2: Unexamined Japanese Patent Application KOKAI Publication No. 2007-257298
Patent Literature 3: Unexamined Japanese Patent Application KOKAI Publication No. 2006-079441
Patent Literature 4: Unexamined Japanese Patent Application KOKAI Publication No. 2003-288361
Patent Literature 5: Unexamined Japanese Patent Application KOKAI Publication No. H11-046215

### DISCLOSURE OF INVENTION

### Problem to be solved by the Invention

However, as is indicated by those related technologies, when only effects by a change in an individual health condition and an activity of an individual are presented, it is not so effective in some cases depending on the user. Moreover, uniform presentation of the information of the other users may cause the user to be unmotivated depending on the characteristic of the user.

In general, for the improvement of the living activity for the reduction of the burden on the health and the environment, better effect may be accomplished by presenting not only general information that can be obtained from an individual activity and over the Internet, but also activities of other people with the same intentions, activities and situations of other families in the same community and activities of a close person, in accordance with the personality and attribute of an individual person.

The present invention is made in view of the above-explained circumstances, and it is an object of the present invention to provide an activity presenting apparatus, an activity data presenting method and a recording medium which can present data representing human activities through a suitable method for assisting/guiding the next activity of a user using a system.

### Means for Solving the Problem

An activity data presenting apparatus according to a first perspective of the present invention comprises:

an activity information obtaining unit that obtains activity data representing a human activity;

a personality data obtaining unit that obtains personality data representing a personality of a person to whom information is presented;

a presenting data selecting unit that selects, on the basis of the person to whom the information is presented and of the personality data of that person, data to be presented among the activity data;

a display method selecting unit that selects a display method of displaying the data to be presented corresponding to each piece of the data representing the personality;

a data processing unit that processes the data to be presented in accordance with the display method selected by the display method selecting unit corresponding to the personality data, obtained by the personality data obtaining unit, of the person to whom the information is presented; and

a display unit that displays the data to be presented which is processed by the data processing unit.

An activity data presenting method according to a second perspective of the present invention comprises:

an activity information obtaining step of obtaining the activity data representing a human activity;

a personality data obtaining step of obtaining personality data representing a personality of a person to whom the information is presented;

a presenting data selecting step of selecting data to be presented among the activity data on the basis of the person to whom the information is presented and of the personality data of that person;

a display method selecting step of selecting a display method of displaying the data to be presented corresponding to each piece of the data representing the personality;

a data processing step of processing the data to be presented in accordance with the display method selected in the display method selecting step corresponding to the personality data, obtained in the personality data obtaining step, of the person to whom the information is presented; and

a display step of displaying the data to be presented which is processed in the data processing step.

A computer-readable recording medium according to a third perspective of the present invention records a program that causes a computer to operate as:

an activity information obtaining unit that obtains activity data representing a human activity;

a personality data obtaining unit that obtains personality data representing a personality of a person to whom the information is presented;

a presenting data selecting unit that selects, on the basis of the person to whom the information is presented and of the personality data of that person, data to be presented among the activity data;

a display method selecting unit that selects a display method of displaying the data to be presented corresponding to each piece of the data representing the personality;

a data processing unit that processes the data to be presented in accordance with the display method selected by the presenting method selecting unit corresponding to the personality data, obtained by the personality data obtaining unit, of the person to whom the information is presented; and

a display unit that displays the data to be presented which is processed by the data processing unit.

### Effect of the Invention

According to the present invention, it is possible to present data representing human activities processed into the form suitable for assisting/guiding an activity in accordance with the personality of a user for each user. Consequently, it becomes possible to assist/guide the next activity of the user using a system.

### BRIEF DESCRIPTION OF DRAWINGS

FIG. 1 is a block diagram showing an illustrative configuration of an activity data presenting system according to a first embodiment of the present invention;

FIG. 2 is a diagram showing an example of personality data according to an embodiment;

FIG. 3 is a diagram showing an example of a correspondence between personality data and a presenting method according to the embodiment;

FIG. 4 is a diagram showing an illustrative information input screen;

FIG. 5 is a diagram showing an example of the way of presenting activity data;

FIG. 6A is a flowchart showing an example of operation of an activity data presenting apparatus according to the first embodiment;

FIG. 6B is a flowchart showing an example of operation of the activity data presenting apparatus according to the first embodiment;

FIG. 7 is a block diagram showing an illustrative configuration of an activity data presenting system according to a second embodiment of the present invention;

FIG. 8 is a diagram showing an example of an activity data collecting system that collects data from an electronic device;

FIG. 9 is a diagram showing an example of an activity data collecting system that obtains data from a store;

FIG. 10 is a diagram showing an example of activity data automatically collected;

FIG. 11 is a diagram showing an example of the way of presenting data including prediction information according to the second embodiment;

FIG. 12 is a flowchart showing an example of operation of an activity data presenting apparatus according to the second embodiment;

FIG. 13 is a block diagram showing an illustrative configuration of an activity data presenting system according to a third embodiment of the present invention;

FIG. 14A is a diagram showing an example of profile information;

FIG. 14B is a diagram showing an example of profile information;

FIG. 15A is a diagram showing an example of the way of presenting to a competitive person which includes related-person comparison-target data;

FIG. 15B is a diagram showing an example of the way of presenting to a person likely to feel togetherness, which includes the related-person comparison-target data;

FIG. 16 is a diagram showing an example of the different way of presentation, including the related-person comparison-target data;

FIG. 17 is a flowchart showing an example of operation of an activity data presenting apparatus according to the third embodiment;

FIG. 18 is a block diagram showing an illustrative configuration of an activity data presenting system according to a forth embodiment of the present invention;

FIG. 19 is a diagram showing an activity data presenting method and an example of comparison between an activity data record and personality data;

FIG. 20 is a flowchart showing an example of operation of a user personality extracting process according to the forth embodiment; and

FIG. 21 is a block diagram showing an illustrative hardware configuration of the activity data presenting apparatus.

### BEST MODE FOR CARRYING OUT THE INVENTION

According to the present invention, data representing human activities is data that represents the contents of human activities, or data that represents, for example, wealth or services which are consumed or produced by human activities. An example of such data is one that represents a learned assignment or an achievement, a kind of an activity done and an amount thereof, a kind and an amount of wealth which are produced, a kind and an amount of a provided service, an amount of consumed resources or energies, or an amount of exhausted materials like greenhouse-effect gases.

### First Embodiment

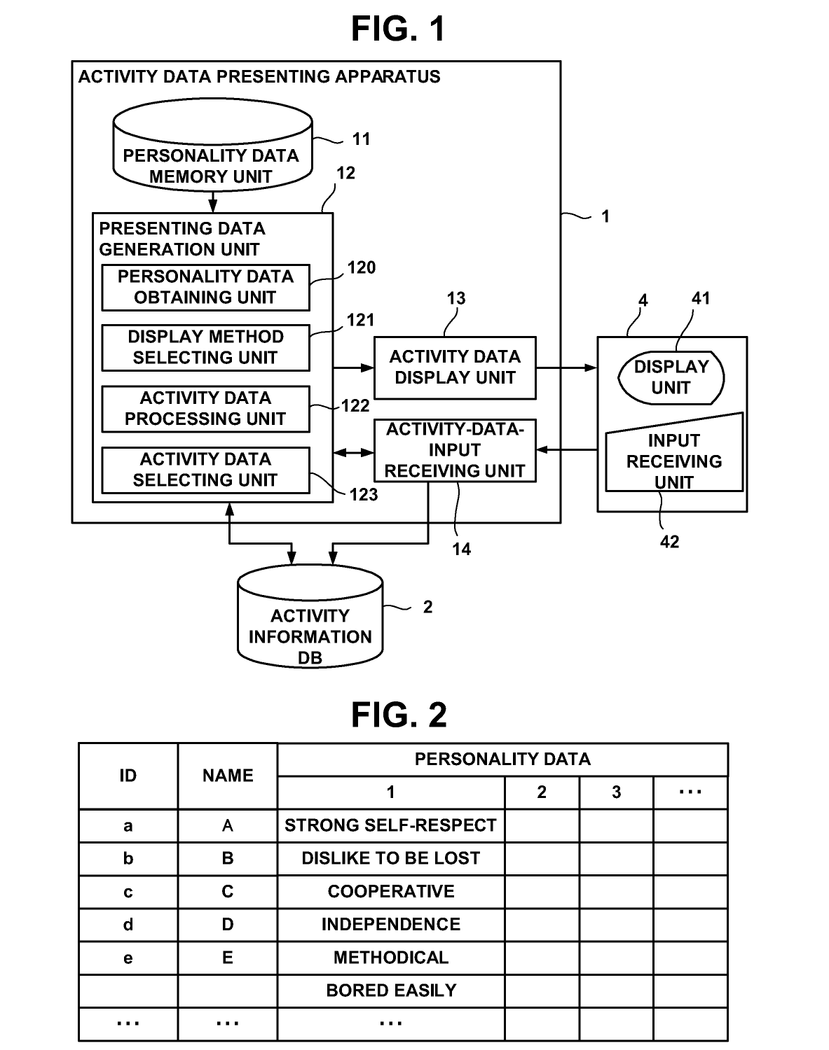

FIG. 1 is a block diagram showing an illustrative configuration of an activity data presenting apparatus according to a first embodiment of the present invention. An activity data presenting system comprises an activity data presenting apparatus 1, an activity information database (hereinafter, referred to as an activity information DB) 2 and a terminal 4. The activity data presenting apparatus 1 and the activity information DB 2, and, the activity data presenting apparatus 1 and the terminal 4 can mutually communicate with each other over a network (which is not shown). The activity information DB 2 may be built in the activity data presenting apparatus 1. Moreover, the terminal 4 is a part of the activity data presenting apparatus 1 or an accessory device thereof.

The activity data presenting apparatus 1 comprises a personality data memory unit 11, a presentation data generation unit 12, an activity data display unit 13 and an activity-data-input receiving unit 14. The presentation data generation unit 12 includes a personality data obtaining unit 120, a display method selecting unit 121, an activity data processing unit 122 and an activity data selecting unit 123.

The personality data memory unit 11 stores data representing the personality of each user to which activity data is presented. Data representing a personality is a code corresponding to a concept that classifies and characterizes the tendency of a human activity into several types. The present invention handles, especially, personality data relating to a tendency that may affect a change in a following activity when data on a human activity is presented.

FIG. 2 shows an example of personality data according to the embodiment. The personality data has an identification code (ID) of each person in association with data representing the personality of that person. Because a character is not always expressed in one type, setting is made so that plural pieces of data are taken as the personality data. For example, when a personality that a person has strong self-respect and an independence but gets bored easily, data that indicates “strong self-respect”, “independence” and “bored easily” is set as the personality data.

In FIG. 2, words, such as “strong self-respect” and “dislike to be lost”, are denoted as the personality data, but such words are for facilitating a person to input the personality data or to refer thereto. In practice, the personality data is a code, and it is appropriate to display personality data if there is a correspondence table between the code and a letter string. The personality data may be input by a user or stored in some way. For example, personality data determined based on the result of a personality assessment test may be given in a storage medium.

The presentation data generation unit 12 selects, for the item of a specified activity, activity data to be presented in accordance with the personality data for each user, processes the activity data in a display method in accordance with the personality data and presents the processed data. Hereinafter, how to select the activity data to be presented and how to display the activity data are together called an activity data presenting method in some cases. The personality data obtaining unit 120 reads the identification code of the user to whom the activity data is presented and obtains the personality data of that user from the personality data memory unit 11 based on the identification code. The activity data selecting unit 123 selects the activity data to be presented corresponding to a user and the personality data of that user. Moreover, the display method selecting unit 121 selects a display method corresponding to the personality data.

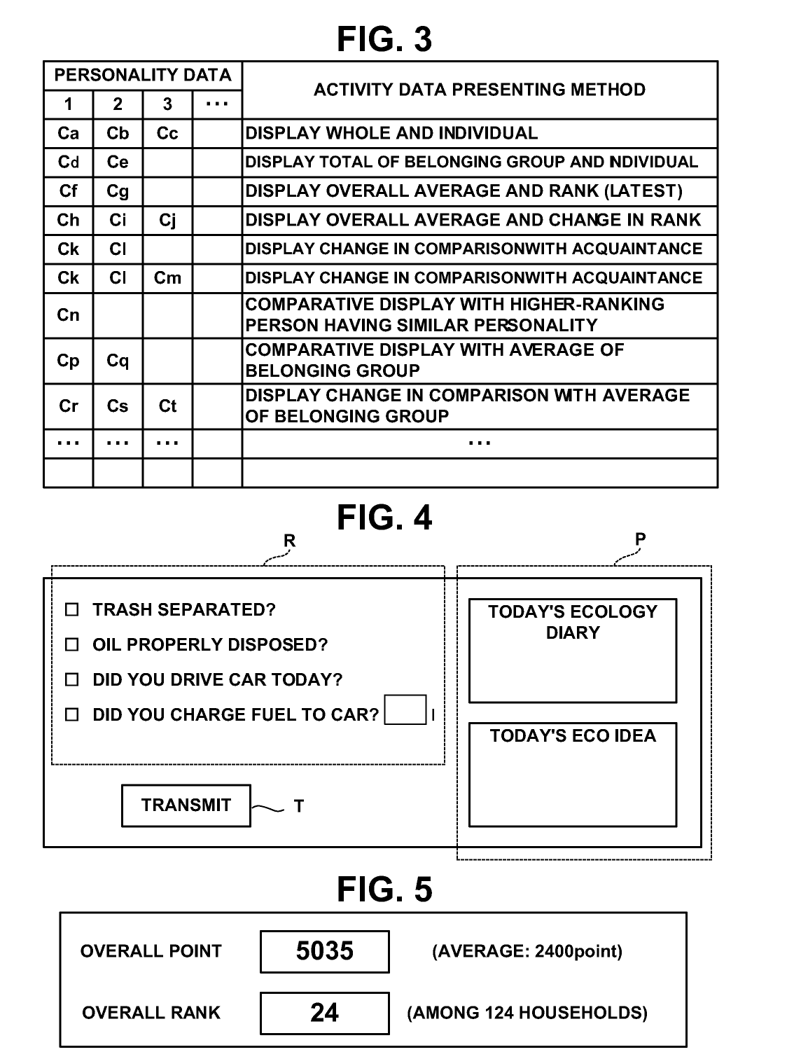

FIG. 3 shows the example correspondence between the personality data and the presenting method according to the embodiment. In FIG. 3, the personality data is indicated by a code like Ca. The presenting method of the activity data is associated with the combination of pieces of the personality data. It is unnecessary that the number of pieces of the personality data is included in the combination of the personality data is a constant. Moreover, the same presenting method may be associated with different combinations of pieces of the personality data.

The activity data selecting unit 123 extracts, from the activity information DB 2, activity data to be presented in accordance with a user and the personality data thereof. The activity data selecting unit extracts, for example, all pieces of activity data in a predetermined recent period for a specified item. Alternatively, the activity data selecting unit may extract only the activity data of a specific user in some cases. The activity data selecting unit sends the extracted activity data to the activity data processing unit 122.

The activity data processing unit 122 processes the activity data received from the activity data selecting unit 123 in accordance with the display method selected by the display method selecting unit 121. The activity data processing unit 122 calculates, for example, the average of all users, data of the user to whom the activity data is presented and the rank thereof for the item. The activity data processing unit 122 sends the processed activity data to the activity data display unit 13. The activity data display unit 13 sends the data generated and processed by the presenting data generation unit 12 to a terminal in a predefined data format like html.

The terminal 4 includes a display unit 41 and an input receiving unit 42. The display unit 41 displays activity data received from the activity data presenting apparatus 1. The display unit 41 also displays a predetermined information input screen for receiving the activity data. The input receiving unit 42 receives an input given by the user like activity data, and sends the received data to the activity presenting apparatus 1. The input receiving unit 42 receives inputting which are for presenting the activity data, for example, which are the user ID to be presented, authentication data, an item to be presented, etc., and sends these pieces of data to the activity data presenting apparatus 1.

FIG. 4 shows an example information input screen. The information input screen includes an input part R in the form of a questionnaire and a free-entry part P. The user can input basic activity information of himself/herself at the present day from the input part R in the form of a questionnaire, and inputs, for example, an environmental activity that is taken extraordinary and an activity which helps to protect the environment and which is newly thought out from the free-entry part P, and clicks a send button T, thereby sending the activity data to the activity data presenting apparatus 1.

The activity-data-input receiving unit 14 of the activity data presenting apparatus 1 receives the activity data from the terminal 4, and stores the received data in the activity information DB 2. The activity-data-input receiving unit 14 also receives an instruction that is for presenting the activity data from the terminal 4, and sends the instruction to the presenting data generation unit 12.

FIG. 5 shows an example of the way of presenting the activity data. In the case of the example shown in FIG. 5, the total point of activities relating to the environmental protection by an individual person, and the average of the total points (pieces of activity data) of the other users using the same system and residents living in the same community are displayed right next to the former total point. Moreover, a rank among the users currently using the system is displayed. The example of the way of presenting shown in FIG. 5 corresponds to the activity data presenting method, the third line in FIG. 3, “Overall Average and Rank Display (Latest)”.

By the way of displaying like FIG. 5, the user is motivated to make further environmental activities. The point reflects information, such as the number of times refusing reception of chopsticks and plastic bags given at a store, and a purchase of an earth-friendly (environmental burden decreasing) product.

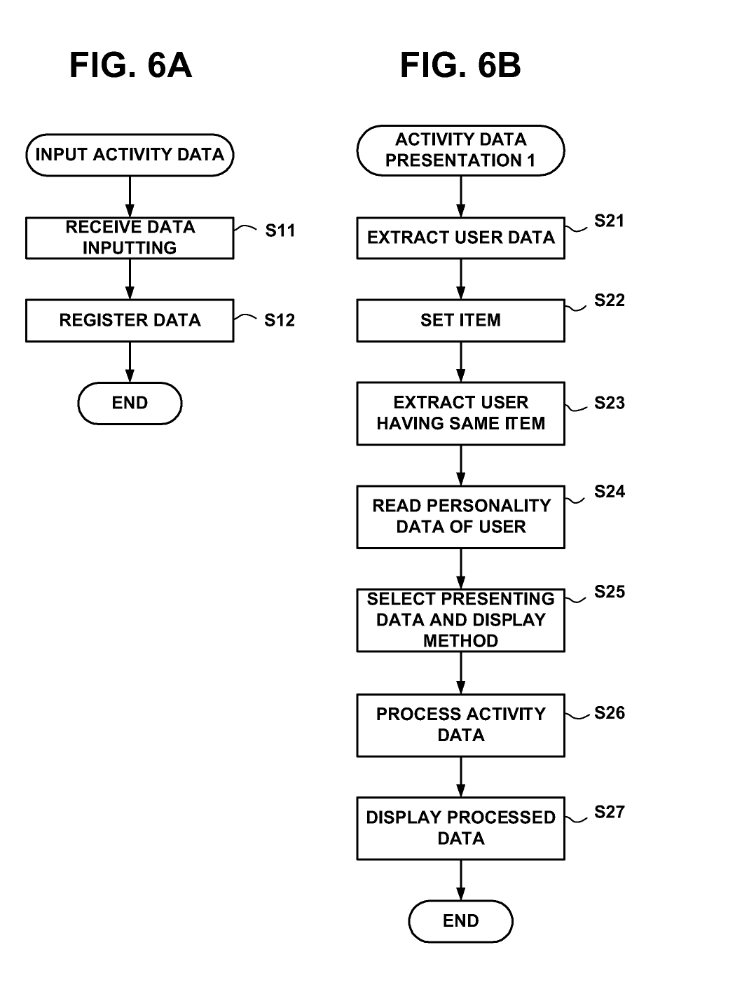

FIGS. 6A and 6B are flowcharts showing an example of operation of the activity data presenting apparatus according to the first embodiment. FIG. 6A shows an operation of inputting activity data, and FIG. 6B shows an operation of presenting the activity data.

Inputting of the activity data and presenting of the activity data are carried out individually. For example, when the user inputs activity data through the information input screen in FIG. 4 and sends the activity data from the terminal 4, the activity-data-input receiving unit 14 receives the activity data from the terminal 4 (step S11), and registers the received activity data in the activity information DB 2 (step S12).

When the user inputs an instruction of presenting user information and activity data from the terminal 4, the activity-data-input receiving unit 14 receives the instruction from the terminal 4, and transmits the instruction to the presenting data generation unit 12. The activity data selecting unit 123 extracts the activity data from the activity information DB 2 with the user information being as a key (step S21). Next, the activity data selecting unit 123 sets (selects) an item of the activity data to be presented based on the instruction (step S22). The activity data selecting unit 123 extracts a user having the same item, and extracts the activity data thereof (step S23).

The presenting data generation unit 12 reads the personality data of the user from the personality data memory unit 11 (step S24). The activity data selecting unit 123 selects activity data to be presented in accordance with the personality of the user, and the display method selecting unit 121 selects a display method corresponding to the personality data of the user (step S25). The activity data processing unit 122 processes, in accordance with the selected presenting method, the activity data extracted by the activity data selecting unit 123 (step S26). The activity data display unit 13 sends the activity data processed by the activity data processing unit 122 to the terminal 4 in the format that the display unit 41 can display. The display unit 41 displays the received activity data (step S27).

As explained above, according to the activity data presenting apparatus 1 of the first embodiment, it is possible to process data representing human activities into the format suitable for assisting/guiding an activity in accordance with the personality of a user. Consequently, it is possible to assist/guide the next activity of the user using the system.

### Second Embodiment

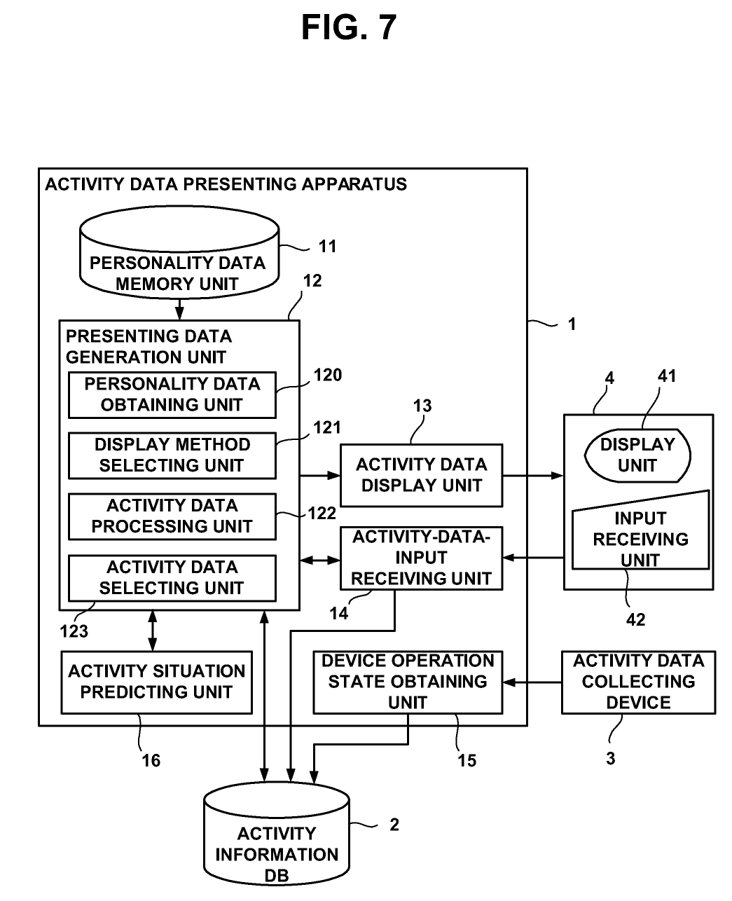

FIG. 7 is a block diagram showing an illustrative configuration of an activity data presenting apparatus 1 according to a second embodiment of the present invention. The activity data presenting apparatus 1 of the second embodiment displays, together with activity data, data representing a situation in future predictable from the activity data. Moreover, the activity data presenting apparatus 1 automatically collects activity data. The activity data presenting apparatus 1 of the second embodiment includes an activity situation predicting unit 16 and a device operation state obtaining unit 15 in addition to the configuration of the first embodiment. Moreover, an activity data presenting system includes an activity data collecting device 3.

The activity situation predicting unit 16 calculates data which represents a situation in future that is conceivable as to be the most probable through a predetermined method in accordance with an item based on the record of activity data. The activity situation prediction unit 16 estimates and calculates, for example, an electricity consumption or an amount of greenhouse-effect gas emission up to the last of a month including the present date based on a set temperature of an air conditioner and operating hours (rate) thereof up to the present date. In the case, the activity situation prediction unit 16 may further calculate a change in the rate relative to the averages of all users and a change in the rank expected in a particular group. Depending on the presenting method of activity data corresponding to the personality of a target user, what data for a future situation is calculated changes.

The activity data collecting device 3 collects data relating to activities of the user. Examples of the data to be collected are the lighting hours of an electric lamp, a set temperature of an air conditioner and operating hours thereof, an exterior temperature and an interior temperature, or lighting intensities of the exterior and the interior. Moreover, activity data relating to the environmental protection, e.g., data whether or not the user consumed a plastic bag by shopping is included in the data to be collected. The activity data collecting device 3 sends the collected activity data to the device operation state obtaining unit 15. The device operation state obtaining unit 15 stores the received data in the activity information DB 2.

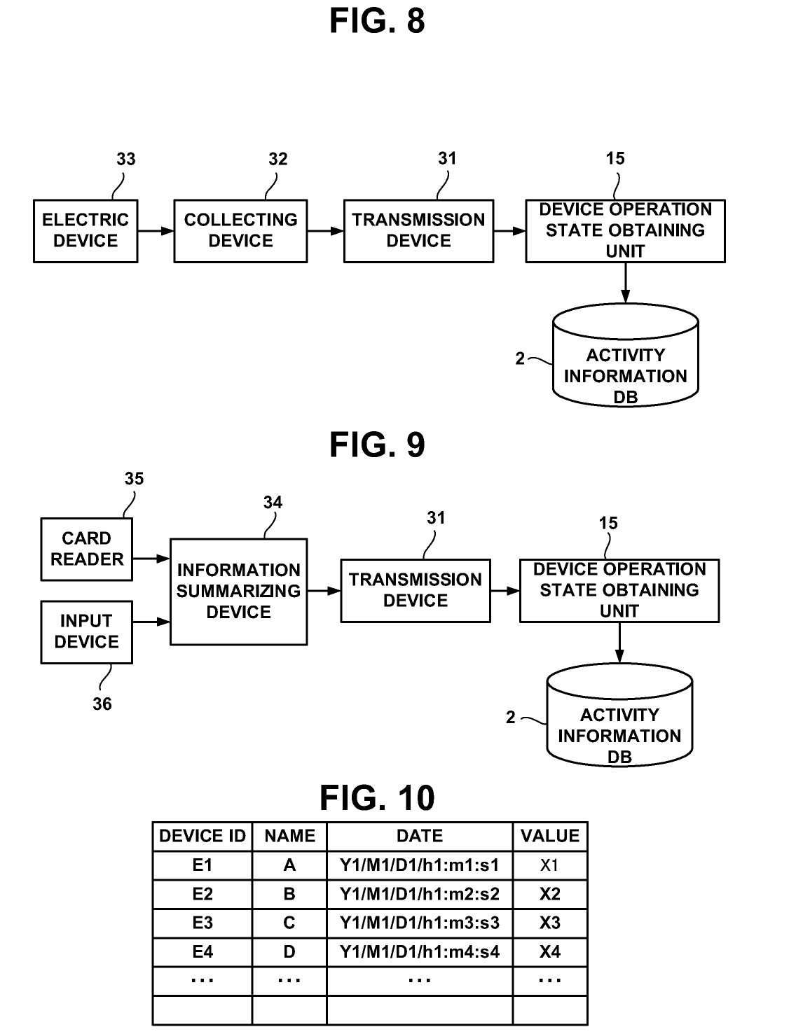

FIG. 8 shows an illustrative activity data collecting system that collects activity data, such as a set temperature and an electricity consumption amount from an electric device. The activity data collecting system shown in FIG. 8 comprises a target electric device 33, a collecting device 32, a transmission device 31, the device operation state obtaining unit 15 and the activity information DB 2. In the example shown in FIG. 8, the electric device 33, the collecting device 32 and the transmission device 31 correspond to the activity data collecting device 3 shown in FIG. 7. The collecting device 32 detects predetermined data from the target electric device 33 regularly or when an operating state changes, and sends the detected data to the device operation state obtaining unit 15 through the transmission device 31.

In addition to the electric device 33, the activity data collecting system may include a sensor which detects an exterior temperature and an interior temperature, lightning intensities of the exterior and the interior or the flow rate of water, and these data may be used as the activity data.

FIG. 9 shows an illustrative system that obtains activity data at a store or the like. The activity data collecting system of FIG. 9 includes a card reader 35, an input device 36, an information summarizing device 34 and the transmission device 31 which configure the activity data collecting device 3. The card reader 35 reads a point card where user information is written. The input device 36 receives inputting of information on a refusal of reception of a plastic bag and a chopstick which are key-assigned to POS (Point Of Sales) or the like, and purchase information on an earth-friendly product. The information summarizing device 34 takes the user information read by the card reader 35 and the activity data input through the input device 36 together. The transmission device 31 sends the user information and the activity data to the device operation state obtaining unit 15. The activity data collecting system shown in FIG. 9 can collect the activity data simultaneously with point registration at the time of payment at a shopping.

FIG. 10 shows an example of activity data automatically collected. A date when the activity data is generated and a value thereof are recorded in association with a device ID and a name. Devices are, as described above, the electric device 33, various kinds of sensors and the information summarizing device 34, etc. The value of the activity data is a set temperature of an air conditioner in operation, a room temperature, a lighting intensity of the interior and consumption/non-consumption of a plastic bag, etc.

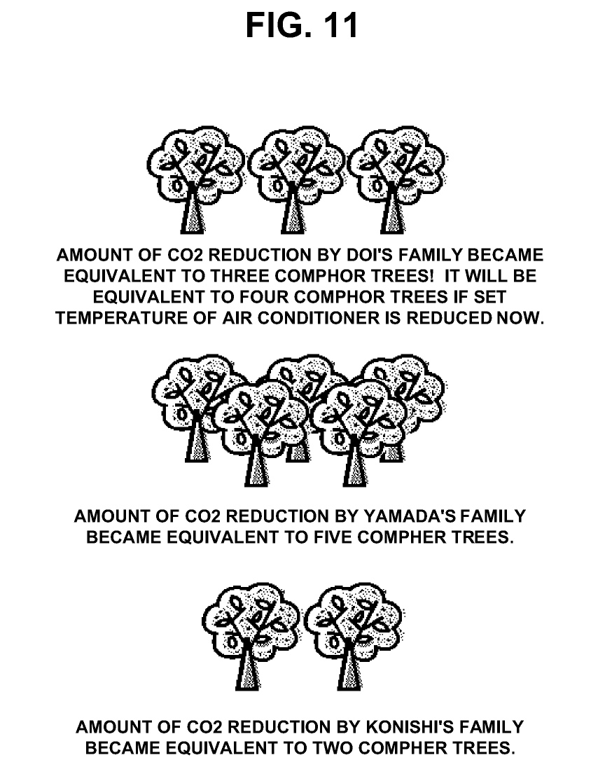

FIG. 11 shows an example of the way of presenting data including prediction information according to the second embodiment. For example, based on the quality and the quantity of the environmental activity of each user, the amount of CO₂ reduction by individual user and data representing a possible situation in future are displayed. Displayed in the case of the example shown in FIG. 11 is data representing an accomplishable situation when a certain condition is added to the set temperature of an air conditioner (cooling equipment) up to the present.

Like indication of a recommended activity in accordance with the personality of a user, as shown in FIG. 11, it is possible to additionally display future prediction data together with a certain condition. By displaying a recommended activity in future as a message together with the simulation result of a reduction amount, it becomes possible to assist the user to have incentives to a next activity.

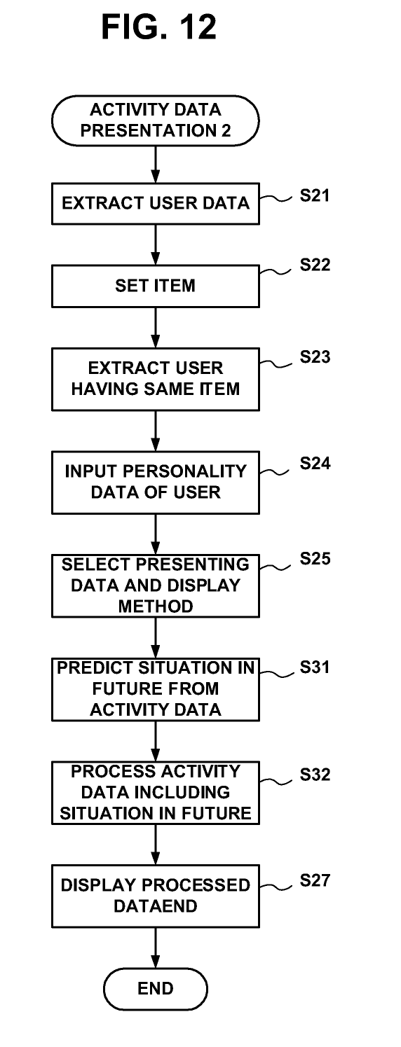

FIG. 12 is a flowchart showing an example operation by the activity data presenting apparatus according to the second embodiment. An operation of predicting a situation in future is added according to the second embodiment. Operations from the extraction of user data (step S21) to the selection of the way of presenting (step S25) are the same as the operations in FIG. 6B.

When the display method selecting unit 121 selects a display method corresponding to the personality data (step S25), the activity situation predicting unit 16 calculates data which represents a situation in future predictable from activity data through a predetermined method based on the selected presenting method and the item of the activity data to be presented (step S 31). The activity data processing unit 122 processes, in accordance with the selected presenting method, the activity data extracted by the activity data selecting unit 123 and the data representing a situation in future calculated by the activity situation predicting unit 16 (step S32).

The activity data display unit 13 sends the activity data processed by the activity data processing unit 122 to the terminal 4 in the format that the display unit 41 can display. The display unit 41 displays the received activity data (step S27).

As described above, according to the activity data presenting apparatus of the second embodiment, the user can predict the result of an activity in future because the activity data presenting apparatus displays data representing a situation in future predictable from the activity data together with such activity data. Consequently, the user can revise an activity in an intended direction. Moreover, regarding the data representing a situation in future, it is possible to assist/guide the next activity of the user more effectively by selection of a presenting method in accordance with the personality of a user.

### Third Embodiment

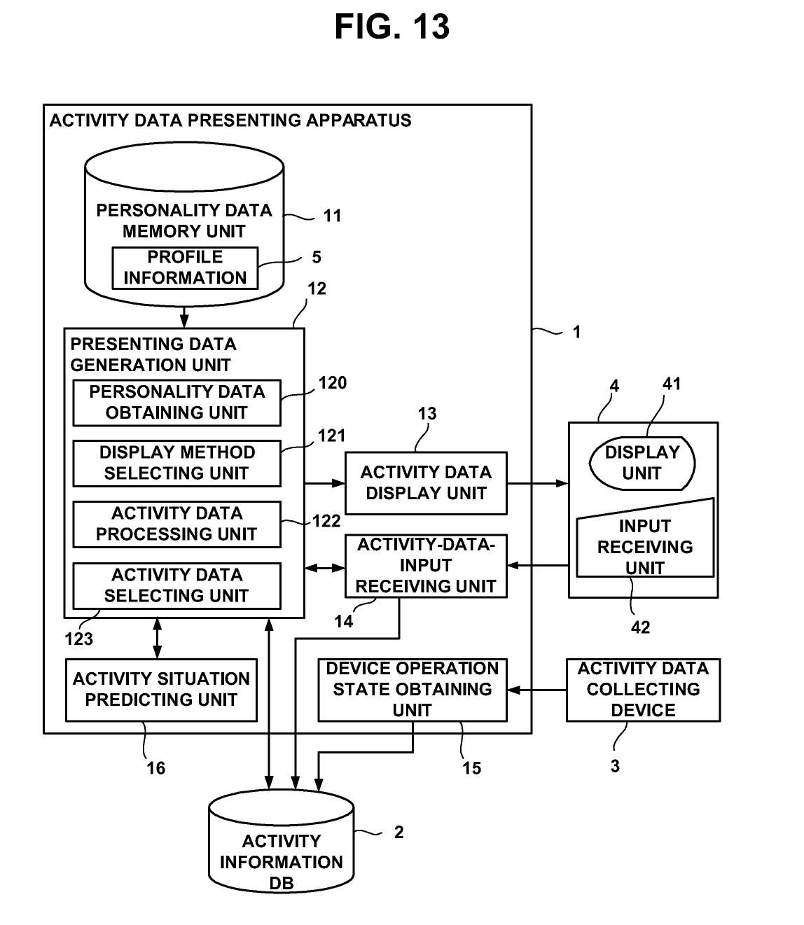

FIG. 13 is a block diagram showing an illustrative configuration of an activity data presenting apparatus according to a third embodiment. The activity data presenting apparatus of the third embodiment presents, together with activity data, activity data of a related person to a user as a comparison target. The related person to the user is, for example, a person who has any common attribute with the user, e.g., the friend or an acquaintance of the user, a person in an organization to which the user belongs, residents living in the same community with the user or a person who shares common interests and background with the user. The related person to the user could be the person who has a certain effect on the user when the activity data of the related person is presented to the user as the comparison target. The name of the related person may be known by the user or may be anonymous that the user cannot know.

Data on mutual relationship between the users or the attribute of the user are included in profile information. An activity data presenting apparatus 1 possesses the profile information. As shown in FIG. 13, a personality data memory unit 11 stores, for example, profile information 5.

A display method selecting unit 121 refers to the profile information 5 and extracts the identification code of the related person to the user when comparison-target data is included in the presenting method selected corresponding to the personality of the user. Next, the display method selecting unit 121 sends the identification code of the related person to an activity data processing unit 122 and an activity data selecting unit 123.

The activity data selecting unit 123 extracts the data on the related person from activity information DB 2 using the identification code of the related person. Moreover, the activity data processing unit 122 processes activity data with the comparison-target data on the related person, and generates presenting data.

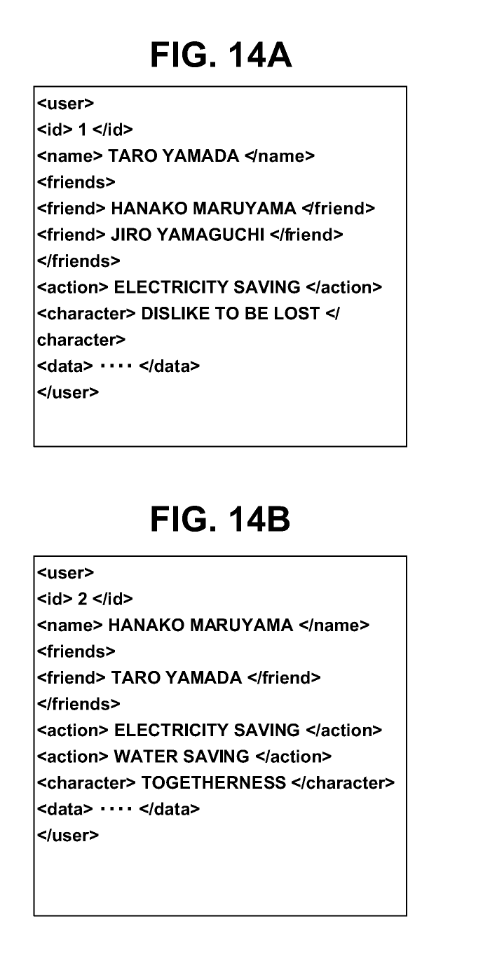

FIGS. 14A and 14B show examples of profile information. FIG. 14A is the profile data when a user id=1, and FIG. 14B is the profile data when a user id=2. A user having the user id=1 has a name (<name>) that is Taro Yamada. The user has friends who are Hanako Maruyama and Jiro Yamaguchi (<friend>). Moreover, the item of activity to be collected/presented (<action>) is “electricity saving”. Furthermore, in the case of FIGS. 14A and 14B, the personality data of the user is also stored, it is shown that the personality of Taro Yamada is “dislike to be lost”.

A user having the user id=2 has a name that is Hanako Maruyama. The user has a friend who is Taro Yamada. Moreover, the items of activity to be collected/presented are “electricity saving” and “water saving”. Furthermore, it is shown that Hanako Maruyama is likely to feel “togetherness”.

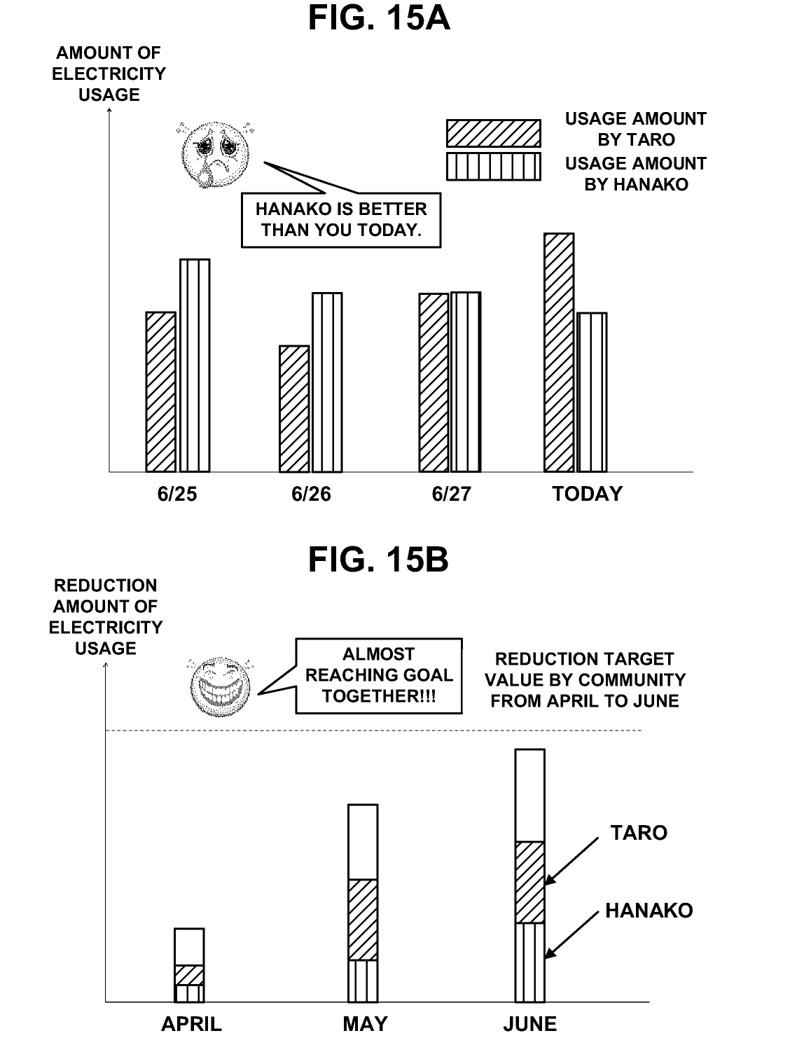

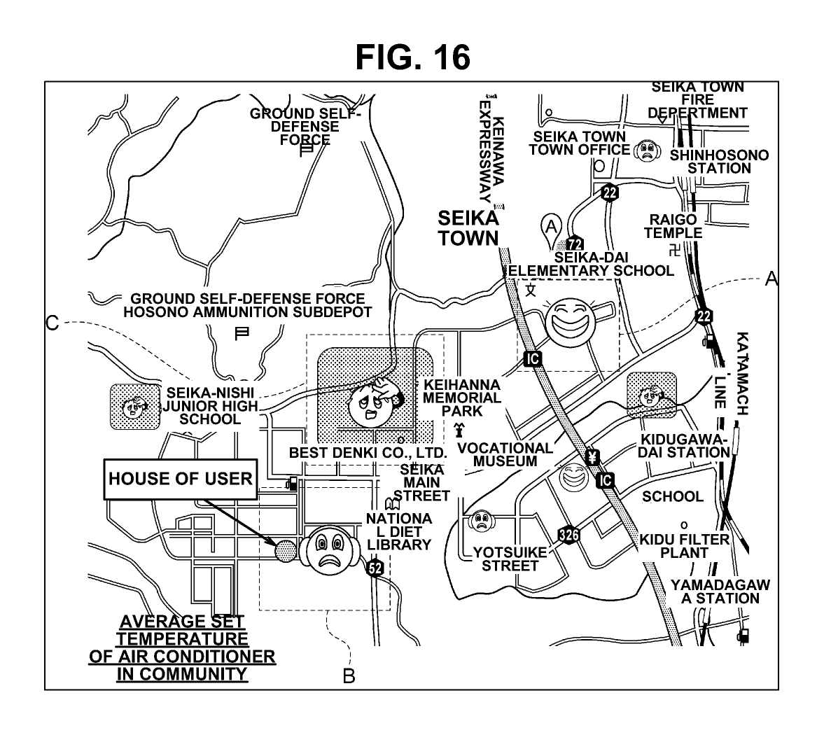

FIG. 15A shows an example way of presenting activity data including related-person comparison-target data to a competitive person. According to FIGS. 14A and 14B, it becomes clear that Mr. Taro Yamada and Ms. Hanako Maruyama are friends each other and Mr. Taro Yamada is a competitive person. Therefore, by presentation of the data of his friend Ms. Hanako Maruyama for comparison in order to get Mr. Taro Yamada to have a competitive emotion, the possibility that Mr. Taro Yamada takes a further electricity-saving activity increases.

FIG. 15B shows an example way of presenting activity data including related-person comparison-target data to a person who is likely to feel togetherness. According to FIGS. 14A and 14B, it becomes clear that Mr. Taro Yamada and Ms. Hanako Maruyama are friends each other and Ms. Hanako Maruyama is likely to feel togetherness. Therefore, by presenting data indicating that Mr. Taro Yamada, a friend of Ms. Hanako Maruyama, had a large amount of electricity saving the last month together with a electricity reduction target value in the whole community, the possibility that Ms. Hanako Yamada takes a further electricity-saving activity in order to contribute to an electricity saving increases.

These ways of presentation are merely examples, and many other ways of the presentation are conceivable as well. For example, as shown in FIG. 11, based on the quality and the quantity of the environmental activity of each user, it is possible to guide and to motivate the user to take a next activity by displaying the amount of CO₂ reduction by related other users together with the presentation of the amount of CO₂ reduction by an individual user.

FIG. 16 shows a different example way of presentation. As is shown in FIG. 16, it is conceivable that the set temperature information of the air conditioner by each user is collected in real time, and the set temperature information is displayed together with user information. FIG. 16 shows an example in which a metaphor A indicating a proper temperature when a set temperature is the proper temperature (28 C.°), a metaphor B indicating a low temperature when the set temperature is the low temperature (equal or less than 28 C.°) and a metaphor C indicating a high temperature when the set temperature is high or the air conditioner is not in operation are displayed. FIG. 16 is an example way of comparing activity information with pieces of activity information of related people who live in the same community, and of presenting those pieces of activity information. It is expected that presentation of the comparison data of other users in real time appeals to the competitive mentality or the cooperative mentality of the user, and the user is caused to increase the set temperature of the air conditioner.

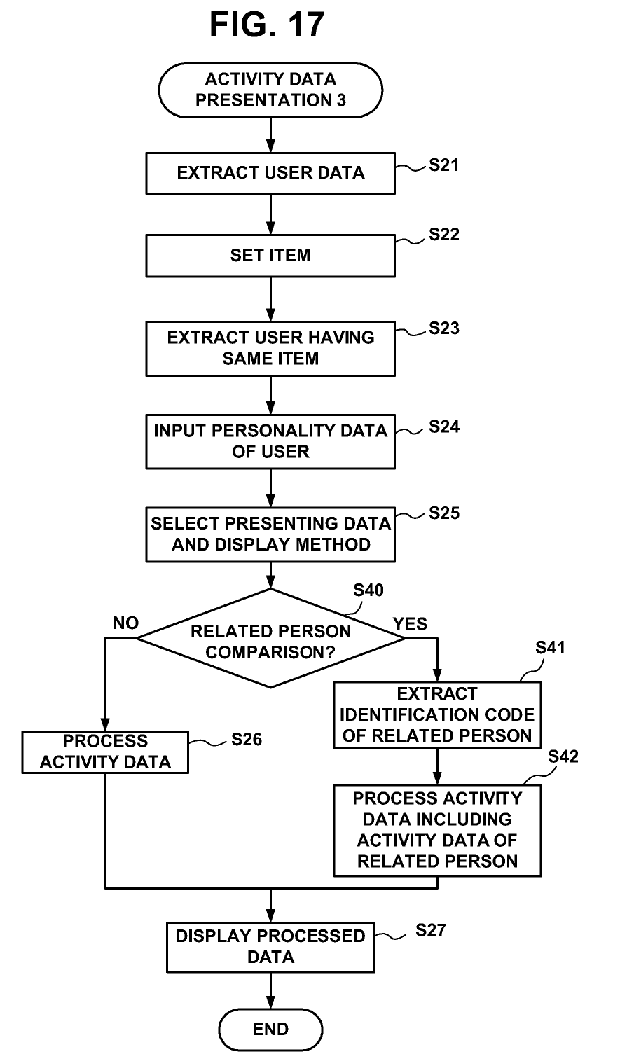

FIG. 17 is a flowchart showing an example of operation of the activity data presenting apparatus according to the third embodiment. An operation of displaying the activity data of the related person as a comparison target is added to those of the third embodiment. Operations from the extraction of user data (step S21) to the selection of the way of displaying (step S25) are the same as the operations in FIG. 6B.

When the display method selecting unit 121 selects a display method corresponding to the personality data (step S25), the display method selecting unit 121 checks whether or not to display the activity data of the related person (a person in relation to the user) as a comparison target (step S40). When a comparison with the activity data of the related person (related person comparison) is not made (step S40; NO), the display method selecting unit processes the activity data in the same way as the operations of FIG. 6B.

In contrast, when the related person comparison is made (step S40; YES), the display method selecting unit refers to the profile information, and extracts the identification code of the related person of the user who is a target person defined in the way of presenting (step S40). The activity data processing unit 122 processes, in accordance with the selected presenting method, the activity data including the activity data of the related person (step S42).

An activity data display unit 13 sends the activity data processed by the activity data processing unit 122 to a terminal 4 in the format that a display unit 41 can display. The display unit 41 displays the received activity data (step S27).

Note that it is omitted in FIG. 17 but the activity data presenting apparatus may include an activity situation predicting unit 16, and the activity situation predicting unit may calculate data representing a situation in future that is predicted from the present activity data through a predetermined method in accordance with the selected presenting method and the item of the activity data to be presented. The activity situation predicting unit 16 further calculates, regarding the activity data of the related person to the target user, data representing a situation in future. The activity data processing unit 122 processes, in accordance with the selected presenting method, the activity data extracted by the activity data selecting unit 123 and the data representing a situation in future calculated by the activity situation predicting unit 16.

As described above, according to the activity data presenting apparatus of the third embodiment, the activity data is presented together with the activity data of the related person to the user in accordance with the personality of the user, which appeals to a user's mental, thereby further effectively assisting/guiding the next activity of the user.

### Forth Embodiment

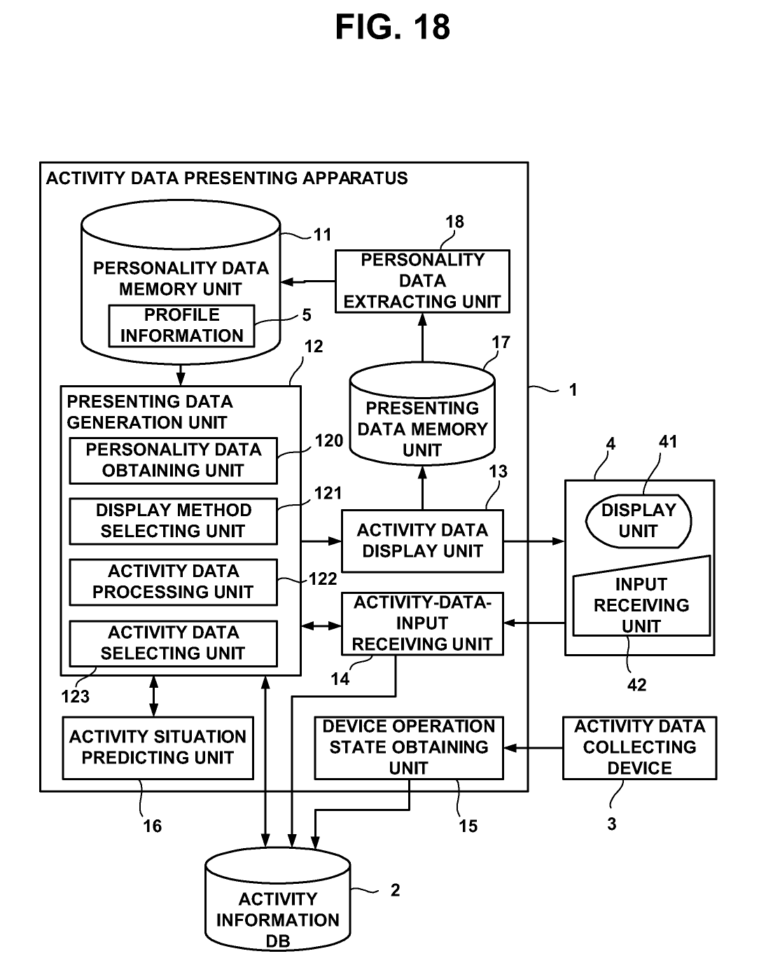

FIG. 18 is a block diagram showing an illustrative configuration of an activity data presenting apparatus according to a forth embodiment. According to the forth embodiment, data representing the personality of a user is determined based on the record of presentation of activity data and a change in the activity data. According to the forth embodiment, an activity data presenting apparatus 1 includes a presenting data memory unit 17 and a personality data extracting unit 18.

The presenting data memory unit 17 stores activity data presented by the activity data display unit 13. That is, the presenting data memory unit stores, for each user, the presenting method of the activity data and a presented value together with the date when the activity data is presented. The presented value includes (the value of) the activity data of a user. Consequently, by checking the record of the presented activity data, the presenting method and a change in the subsequent activity data can be figured out.

The personality data extracting unit 18 determines the personality of a user based on the record of the presenting method of activity data and the change in the activity data. For example, the personality data extracting unit 18 selects personality data that corresponds to a change pattern of the activity data after activity data is presented to the user through a certain presenting method, as the personality data of the user. Next, the personality data extracting unit 18 registers the selected personality data as the personality data of the user to a personality data memory unit 11.

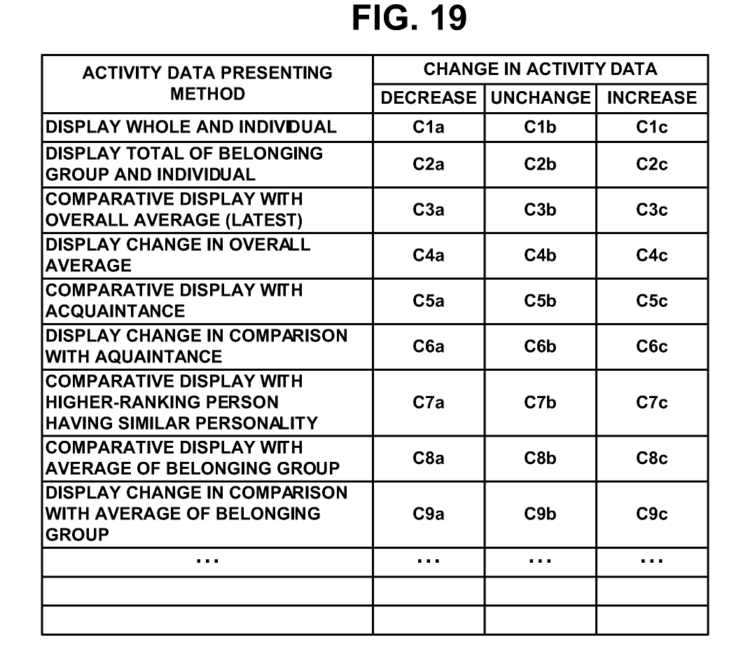

FIG. 19 shows a presenting method of activity data and an example of comparison between an activity data record and personality data. Reference symbols Cna, Cnb and Cnc (where n is a natural number) in FIG. 9 indicate respective pieces of personality data. The personality data extracting unit 18 presents activity data through a certain method, and selects corresponding personality data based on whether the activity data decreases, remains same or increases. The decreasing, the unchanging or the increasing of the activity data may be each defined by a value having a certain range.

As described with reference to FIG. 2, the personality data is not always a piece of data. A presenting method that represents a remarkable change in the activity data may be selected from plural presenting methods, and the data may be set as the personality data of that user. As a result, the personality data is set so that an effective presenting method is selected for that user.

In a situation in which personality data is not initially set, a display method selecting unit 121 selects the presenting method at random and presents the activity data, and stores the record of the presentation of the activity data. As described above, the personality data is set based on the record of the presentation of the activity data. Moreover, when the user sets his/her own personality data, the display method selecting unit may attempt to select a presenting method other than the presenting method being determined only by that personality data, determine the personality data based on those records of the presentations and set it again. This brings about an expectation that a further effective presenting method is selected.

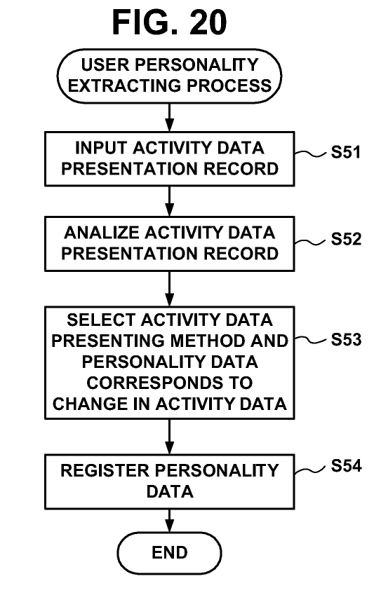

FIG. 20 is a flowchart showing an example operation of a user personality extracting process according to the forth embodiment. The activity data display unit 13 stores, when presenting activity data, that activity data in the presenting data memory unit 17. The user personality extracting process is launched regularly or by an operator.

Upon launching of the user personality extracting process, the personality data extracting unit 18 reads an activity data presentation record from the presenting data memory unit 17 (step S51). Next, the personality data extracting unit 18 analyzes the presentation record of the activity data, and checks the selected presenting method and a change in the subsequent activity data (step S52).

The personality data extracting unit 18 selects, for example, from a comparison table shown in FIG. 19, personality data corresponding to the activity data presenting method and a change in the activity data (step S53). Moreover, the personality data extracting unit 18 registers the selected personality data to the personality data memory unit 11 (step S54).

As described above, according to the activity data presenting apparatus of the forth embodiment, the personality data is set so that an effective presenting method for each user is selected. As a result, it is expected that a further effective presenting method is selected.

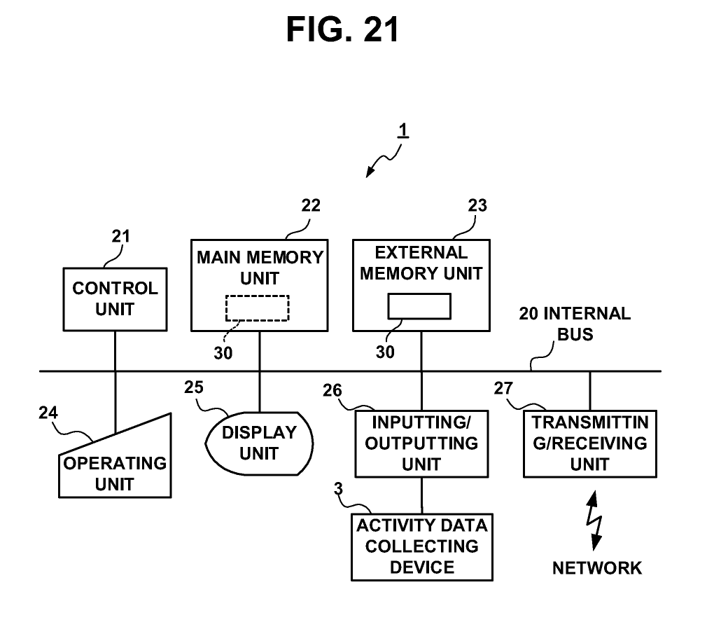

FIG. 21 is a block diagram showing an illustrative hardware configuration of the activity data presenting apparatus 1 shown in FIG. 1, 7, 13 or 18. The activity data presenting apparatus 1 includes, as shown in FIG. 21, a control unit 21, a main memory unit 22, an external memory unit 23, an operating unit 24, a display unit 25, an inputting/outputting unit 26 and a transmitting/receiving unit 27. The main memory unit 22, the external memory unit 23, the operating unit 24, the display unit 25, the inputting/outputting unit 26 and the transmitting/receiving unit 27 all are connected to the control unit 21 through an internal bus 20.

The control unit 21 comprises a CPU (Central Processing Unit), etc., and executes individual processes of the presenting data generation unit 12, the activity data display unit 13 and the activity-data-input receiving unit 14 of the activity data presenting apparatus 1 in accordance with a control program 30 stored in the external memory unit 23.

The main memory unit 22 comprises a RAM (Random-Access Memory), etc., and loads the control program 30 stored in the external memory unit 23, and is used as a work area for the control unit 21.

The external memory unit 23 comprises a nonvolatile memory, e.g., a flash memory, a hard disk, a DVD-RAM (Digital Versatile Disc Random-Access Memory) or a DVD-RW (Digital Versatile Disc ReWritable), stores a program beforehand for causing the control unit 21 to execute the process of the activity data presenting apparatus 1, and in accordance with the instruction from the control unit 21, supplies data stored in that program to the control unit 21 and stores data supplied from the control unit 21.

The personality data memory unit 11 and the presenting data memory unit 17 of the activity data presenting apparatus 1 are configured by the external memory unit 23. An activity information DB 2 may be configured by the external memory unit 23 in some cases.

The operating unit 24 comprises a pointing device, such as a keyboard and a mouse, and an interface device that connects the keyboard, the pointing device, etc., to the internal bus 20. Personality data and profile information, etc. are input through the operating unit 24, and are supplied to the control unit 21. In a configuration in which the terminal 4 shown in FIG. 1, 7, 13 or 18 is included in the activity data presenting apparatus 1, the operating unit 24 may serve as the input receiving unit 42.

The display unit 25 comprises a CRT (Cathode Ray Tube) or an LCD (Liquid Crystal Display), etc., and displays information on a person and an object registered as a target subjected to the positional detection, position information and contact information. In the configuration in which the terminal 4 shown in FIG. 1, 7, 13 or 18 is included in the activity data presenting apparatus 1, the display unit 25 may serve as the display unit 41.

The inputting/outputting unit 26 comprises a serial interface or a parallel interface. When the terminal 4 is an associated device of the activity data presenting apparatus 1, the inputting/outputting unit 26 is connected to the terminal 4. The inputting/outputting unit 26 is connected to an activity data collecting device 3.

The transmitting/receiving unit 27 comprises a network termination device or a wireless communication device connected to a network, and a serial interface or a LAN (Local Area Network) interface connected to the network termination device or the wireless communication device. The transmitting/receiving unit 27 transmits, through the network to the activity information DB 2, the identification code of a target person to whom activity data is presented and an item to be presented, and receives the activity data. When the terminal 4 is a separate terminal device from the activity data presenting apparatus 1, the activity data presenting apparatus is connected to the terminal 4 through, for example, the transmitting/receiving unit 27 and the network.

The processes of the presenting data generation unit 12, the activity data display unit 13, the activity-data-input receiving unit 14, the device operation state obtaining unit 15, the activity situation predicting unit 16 and the personality data extracting unit 18 of the activity data presenting apparatus 1 shown in FIG. 1, 7, 13 or 18 are executed by the control program 30 that executes processes using the control unit 21, the main memory unit 22, the exterior memory unit 23, the operating unit 24, the display unit 25, the inputting/outputting unit 26 and the sending/receiving unit 27, etc., as resources.

In addition to the above-explained configuration, as preferred modifications of the present invention, following configurations may be employed.

An activity data presenting apparatus according to a first perspective of the present invention preferably comprises;

a predicting unit that calculates data representing a situation in future regarding the person to whom the information is presented through a predetermined method from the activity data obtained by the activity information obtaining unit; and

a predicted situation presenting unit that presents the data representing the situation in future calculated by the predicting unit.

The activity data presenting apparatus preferably further comprises,

a relationship obtaining unit that obtains relationship data representing a relationship between the person to whom the information is presented and a person who is the subject of the activity data obtained by the activity information obtaining unit, wherein

the presenting data selecting unit includes the activity data of a person having the predetermined relationship data representing the relationship with the person to whom the information is presented in the data to be presented to the person to whom the information is presented,

the display method selecting unit selects a display method of displaying the activity data of the person having the predetermined relationship data representing the relationship with the person to whom the information is presented as a target for comparison to the activity data of the person to whom the information is presented, and

when the display method selecting unit selects the display method of displaying the activity data of the person having the predetermined relationship data representing the relationship with the person to whom the information is presented as the target for comparison to the activity data of the person to whom the information is presented, the data processing unit includes the activity data of the person having the predetermined relationship data representing the relationship with the person to whom the information is presented in the activity data to be processed.

Preferably, the predetermined relationship data with the person to whom the information is presented includes data which represents that the person who is the subject to presentation of the activity data is in an acquaintance relationship with the person to whom the information is presented.

Preferably, the predetermined relationship data with the person to whom the information is presented includes data which represents that an attribute of the person who is the subject to presentation of the activity data is in a predetermined range in comparison with that of the person to whom the information is presented.

Preferably, the personality data obtaining unit selects, on the basis of a display record of the activity data processed by the data processing unit and of a record of activity data of the person to whom the information is presented, the personality data of the person to whom the information is presented among predetermined personality data.

Preferably, the activity information obtaining unit includes an inputting unit which receives an input given by a person, and

the activity data includes data inputted through the inputting unit.

Preferably, the activity information obtaining unit includes a detecting unit which detects an operating state of a device operated by a person, and

the activity data includes data representing the operating state of the device detected by the detecting unit.

Preferably, the data representing the human activity includes data representing a consumed amount of material or energy.

An activity data presenting method according to a second perspective of the present invention preferably comprises;

a predicting step of calculating data representing a situation in future regarding the person to whom the information is presented through a predetermined method from the activity data obtained in the activity information obtaining step; and

a predicted situation presenting step of presenting the data representing the situation in future calculated in the predicting step.

Preferably, the activity data presenting method further comprises:

a relationship obtaining step of obtaining relationship data representing a relationship between the person to whom the information is presented and a person who is the subject of the activity data obtained in the activity information obtaining step, wherein

the presenting data selecting step includes a step of including activity data of a person having the predetermined relationship data representing the relationship with the person to whom the information is presented in data to be presented to the person to whom the information is presented,

the display method selecting step includes a step of selecting a display method of displaying the activity data of the person having the predetermined relationship data representing the relationship with the person to whom the information is presented as a target for comparison to the activity data of the person to whom the information is presented, and

when, in the display method selecting step, the display method of displaying the activity data of the person having the predetermined relationship data representing the relationship with the person to whom the information is presented as the target for comparison to the activity data of the person to whom the information is presented is selected, the data processing step includes a step of including the activity data of the person having the predetermined relationship data representing the relationship with the person to whom the information is presented in the activity data to be processed.

Preferably, the predetermined relationship data with the person to whom the information is presented includes data which represents that the person who is the subject to presentation of the activity data is in an acquaintance relationship with the person to whom the information is presented.

Preferably, the predetermined relationship data with the person to whom the information is presented includes data which represents that an attribute of the person who is the subject to presentation of the activity data is in a predetermined range in comparison with that of the person to whom the information is presented.

Preferably, in the personality data obtaining step, on the basis of a display record of the activity data processed in the data processing step and of a record of activity data of the person to whom the information is presented, the personality data of the person to whom the information is presented is selected among predetermined personality data.

Preferably, the activity information obtaining step includes an inputting step of receiving an input given by a person, and

the activity data includes the data inputted in the inputting step.

Preferably, the activity information obtaining step includes a detecting step of detecting an operating state of a device operated by a person, and

the activity data includes data represents the operating state of the device detected in the detecting step.

Preferably, the data representing the human activity includes data representing a consumed amount of material or energy.

In addition, the above-explained hardware configurations and flowcharts are merely examples, and can be changed and modified arbitrarily.

The main part of executing the activity data presentation process which comprises the presenting data generation unit 12, the activity data display unit 13, the activity-data-input receiving unit 14, the device operation state obtaining unit 15, the activity situation predicting unit 16 and the personality data extracting unit 18 can be realized by a general computer system not by an exclusive system. For example, a computer program for executing the above-explained operation may be stored in a computer-readable recording medium (e.g., a flexible disk, a CD-ROM or a DVD-ROM) and distributed, and installed on a computer, thereby configuring an activity data presenting apparatus executing the above-explained operation. Moreover, such a computer program may be stored in the storage device of a server device over a communications network like the Internet, and downloaded by a general computer system, thereby configuring the activity data presenting apparatus.

Moreover, when the activity data presenting apparatus is realized by cooperative operation by an OS (Operating System) and an application program or sheared operations, only the application program part may be stored in a recording medium or a storage device.

Furthermore, the computer program may be superimposed on a carrier wave and may be distributed over the communication network. The computer program may pasted on a bulleting board (BBS: Bulleting Board System) over the communication network, and may be distributed over the network. Next, the computer program is launched, and executed under the control of the OS in the same way as the other application programs, thereby enabling execution of the above-explained process.

This application is based on Japanese Patent Application No. 2008-233983 filed on Sep. 11, 2008. The entire disclosure of the specification, the claims, and the drawings of such Japanese Patent Application is incorporated herein by reference in this specification.

### INDUSTRIAL APPLICABILITY

According to the present invention, the present invention can be applied to an application of summarizing opinions by allowing plural users to share a future event predictable from collected pieces of data and further can be applied to an application of improving the activity of a user using the system by presenting information including the data of other users which is extracted and formatted from data input or automatically obtained from unspecified large number of users in a suitable form to the user currently using the system, and a future event predictable from the collected data and the activity of the user. Moreover, the present invention can be also applied to an application of assisting a user who does not know what action he/she should take next by causing such a user to know the activities of other users.

### DESCRIPTION OF REFERENCE NUMERALS

1 Activity data presenting apparatus
2 Activity information database
3 Activity data collecting device
4 Terminal
5 Profile information
11 Personality data memory unit
12 Presenting data generation unit
13 Activity data display unit
14 Activity-data-input receiving unit
15 Device operation state obtaining unit
16 Activity situation predicting unit
17 Presenting data memory unit
18 Personality data extracting unit
21 Control unit
22 Main memory unit
23 External memory unit
24 Operating unit
25 Display unit
26 Inputting/outputting unit
27 Transmitting/receiving unit
30 Control program
41 Display unit
42 Input receiving unit
120 Personality data obtaining unit
121 Display method selecting unit
122 Activity data processing unit
123 Activity data selecting unit

1. An activity data presenting apparatus comprising:
an activity information obtaining unit that obtains activity data representing a human activity;
a personality data obtaining unit that obtains personality data representing a personality of a person to whom information is presented;
a presenting data selecting unit that selects, on the basis of the person to whom the information is presented and of the personality data of that person, data to be presented among the activity data;
a display method selecting unit that selects a display method of displaying the data to be presented corresponding to each piece of the data representing the personality;
a data processing unit that processes the data to be presented in accordance with the display method selected by the display method selecting unit corresponding to the personality data, obtained by the personality data obtaining unit, of the person to whom the information is presented; and
a display unit that displays the data to be presented which is processed by the data processing unit.

2. The activity data presenting apparatus according to claim 1 further comprising:
a predicting unit that calculates data representing a situation in future regarding the person to whom the information is presented through a predetermined method from the activity data obtained by the activity information obtaining unit; and
a predicted situation presenting unit that presents the data representing the situation in future calculated by the predicting unit.

3. The activity data presenting apparatus according to claim 1 further comprising:
a relationship obtaining unit that obtains relationship data representing a relationship between the person to whom the information is presented and a person who is the subject of the activity data obtained by the activity information obtaining unit, wherein
the presenting data selecting unit includes activity data of a person having the predetermined relationship data representing the relationship with the person to whom the information is presented in the data to be presented to the person to whom the information is presented,
the display method selecting unit selects a display method of displaying the activity data of the person having the predetermined relationship data representing the relationship with the person to whom the information is presented as a target for comparison to the activity data of the person to whom the information is presented, and
when the display method selecting unit selects the display method of displaying the activity data of the person having the predetermined relationship data representing the relationship with the person to whom the information is presented as the target for comparison to the activity data of the person to whom the information is presented, the data processing unit includes the activity data of the person having the predetermined relationship data representing the relationship with the person to whom the information is presented in the activity data to be processed.

4. The activity data presenting apparatus according to claim 3, wherein the predetermined relationship data with the person to whom the information is presented includes data which represents that the person who is the subject to presentation of the activity data is in an acquaintance relationship with the person to whom the information is presented.

5. The activity data presenting apparatus according to claim 3, wherein the predetermined relationship data with the person to whom the information is presented includes data which represents that an attribute of the person who is the subject to presentation of the activity data is in a predetermined range in comparison with that of the person to whom the information is presented.

6. The activity data presenting apparatus according to claim 1, wherein the personality data obtaining unit selects, on the basis of a display record of the activity data processed by the data processing unit and of a record of activity data of the person to whom the information is presented, the personality data of the person to whom the information is presented among predetermined personality data.

7. The activity data presenting apparatus according to claim 1, wherein
the activity information obtaining unit includes an inputting unit which receives an input given by a person, and
the activity data includes the data inputted through the inputting unit.

8. The activity presenting apparatus according to claim 1, wherein
the activity information obtaining unit includes a detecting unit which detects an operating state of a device operated by a person, and
the activity data includes data represents the operating state of the device detected by the detecting unit.

9. The activity data presenting apparatus according to claim 1, wherein the data representing the human activity includes data representing a consumed amount of material or energy.

10. An activity data presenting method comprising:
an activity information obtaining step of obtaining activity data representing a human activity;
a personality data obtaining step of obtaining personality data representing a personality of a person to whom the information is presented;
a presenting data selecting step of selecting data to be presented among the activity data on the basis of the person to whom the information is presented and of the personality data of that person;
a display method selecting step of selecting a display method of displaying the data to be presented corresponding to each piece of the data representing the personality;
a data processing step of processing the data to be presented in accordance with the display method selected in the display method selecting step corresponding to the personality data, obtained in the personality data obtaining step, of the person to whom the information is presented; and
a display step of displaying the data to be presented which is processed in the data processing step.

11. The activity data presenting method according to claim 10 further comprising:
a predicting step of calculating data representing a situation in future regarding the person to whom the information is presented through a predetermined method from the activity data obtained in the activity information obtaining step; and
a predicted situation presenting step of presenting the data representing the situation in future calculated in the predicting step.

12. The activity data presenting method according to claim 10 further comprising:
a relationship obtaining step of obtaining relationship data representing a relationship between the person to whom the information is presented and a person who is the subject of the activity data obtained in the activity information obtaining step, wherein
the presenting data selecting step includes a step of including activity data of a person having the predetermined relationship data representing the relationship with the person to whom the information is presented in the data to be presented to the person to whom the information is presented,
the display method selecting step includes a step of selecting a display method of displaying the activity data of the person having the predetermined relationship data representing the relationship with the person to whom the information is presented as a target for comparison to the activity data of the person to whom the information is presented, and
when, in the display method selecting step, the display method of displaying the activity data of the person having the predetermined relationship data representing the relationship with the person to whom the information is presented as the target for comparison to the activity data of the person to whom the information is presented is selected, the data processing step includes a step of including the activity data of the person having the predetermined relationship data representing the relationship with the person to whom the information is presented in the activity data to be processed.

13. The activity data presenting method according to claim 12, wherein the predetermined relationship data with the person to whom the information is presented includes data which represents that the person who is the subject to presentation of the activity data is in an acquaintance relationship with the person to whom the information is presented.

14. The activity data presenting method according to claim 12, wherein the predetermined relationship data with the person to whom the information is presented includes data which represents that an attribute of the person who is the subject to presentation of the activity data is in a predetermined range in comparison with that of the person to whom the information is presented.

15. The activity data presenting method according to claim 10, wherein, in the personality data obtaining step, on the basis of a display record of the activity data processed in the data processing step and of a record of activity data of the person to whom the information is presented, the personality data of the person to whom the information is presented is selected among predetermined personality data.

16. The activity data presenting method according to claim 10, wherein
the activity information obtaining step includes an inputting step of receiving an input given by a person, and
the activity data includes the data inputted in the inputting step.

17. The activity data presenting method according to claim 10, wherein
the activity information obtaining step includes a detecting step of detecting an operating state of a device operated by a person, and
the activity data includes data represents the operating state of the device detected in the detecting step.

18. The activity data presenting method according to claim 10, wherein the data representing the human activity includes data representing a consumed amount of material or energy.

19. A computer-readable recording medium recording a program that causes a computer to operate as:
an activity information obtaining unit that obtains activity data representing a human activity;
a personality data obtaining unit that obtains personality data representing a personality of a person to whom the information is presented;
a presenting data selecting unit that selects, on the basis of the person to whom the information is presented and of the personality data of that person, data to be presented among the activity data;
a display method selecting unit that selects a display method of displaying the data to be presented corresponding to each piece of the data representing the personality;
a data processing unit that processes the data to be presented in accordance with the display method selected by the presenting method selecting unit corresponding to the personality data, obtained by the personality data obtaining unit, of the person to whom the information is presented; and
a display unit that displays the data to be presented which is processed by the data processing unit.
